(19) United States
(12) Patent Application Publication
(10) Pub. No.: US 2017/0126099 A1
(43) Pub. Date: May 4, 2017

(54) Electric Motor Capable of Dissipating Heat Therein

(71) Applicant: Wen-San CHOU, TAINAN (TW)

(72) Inventor: Wen-San CHOU, TAINAN (TW)

(21) Appl. No.: 15/339,337

(22) Filed: Oct. 31, 2016

(30) Foreign Application Priority Data
Nov. 2, 2015 (TW) 104217543

(51) Int. Cl. H02K 9/06; H02K 5/20

(52) U.S. Cl. CPC H02K 9/06; H02K 5/20

(57) ABSTRACT

An electric motor generally includes a housing, a cover, and a cooling fan. The cover defines multiple inlet holes and is formed integrally with an air collecting ring around the inlet holes so as to provide an airflow path for allowing a central portion of the air current generated by the cooling fan to enter the housing. The housing defines a plurality of communication holes and a plurality of outlet holes for allowing the air which has entered the housing to flow thereout. In addition, the present invention provides another path so that an outer portion of the air current can flow along the outer surface of the housing to reduce the temperature of the housing. Through multiple paths for heat dissipation, heat is not easy to accumulate in the housing of the electric motor.

### (a) TECHNICAL FIELD OF THE INVENTION

The present invention relates to an electric motor capable of dissipating heat therein and, more particularly, to an electric motor which can effectively dissipate the heat generated in its housing through multiple paths, so that heat is not easy to accumulate in the electric motor's housing; thus, maximum power output of the electric motor can be achieved, and the performance and service life of the electric motor can be increased.

### (b) DESCRIPTION OF THE PRIOR ART

In today's industry, motors are one of commonly used devices for providing mechanical power. However, while a motor is running, heat is easy to accumulate in the motor's housing. If the heat is not timely dissipated, the magnetic field provided by the magnets in the motor's housing will decrease, so that the performance of the motor can be gradually reduced. Besides, when the temperature in the motor rises to a certain level, the coils or enamel wires in the motor can be damaged, and this may cause a short circuit, and thus the motor may burn out. For preventing such a problem, a motor is usually provided with a cooling fan. However, the air current generated by the cooling fan of the motor can only flow along the outer surface of the motor's housing, but cannot flow into the interior of the motor, and thus the capacity of dissipating the heat generated in the motor is limited. The problem of heat accumulation in the motor's housing has not yet been solved completely.

### SUMMARY OF THE INVENTION

One object of the present invention is to provide an electric motor, which can effectively dissipate the heat generated in its housing through multiple paths.

According to one feature of the present invention, the electric motor generally includes a housing, a cover, a rotating shaft, and a cooling fan. The housing has a surrounding wall defining therein an inner space with a front opening and has a rear closure wall opposite to the front opening. The rear closure wall defines a central hole and a plurality of outlet holes. The cover, which closes the front opening of the housing, has a central hub defining a central hole and has a peripheral portion integrally formed around the central hub. The peripheral portion of the cover is formed integrally with an air collecting ring around the central hub and defines a plurality of inlet holes between the air collecting ring and the central hub, whereby a central portion of a whirling, ongoing air current generated by the cooling fan can flow through the space between the air collecting ring and the central hub of the cover and then flow through the inlet holes of the cover to enter the inner space of the housing and finally flow out of the housing via the outlet holes for dissipating the heat generated in the housing.

According to another feature of the present invention, the housing defines at least one communication hole at its surrounding wall, so that the air current having entered the inner space of the housing may flow out of the housing via the communication hole in addition to the outlet holes of the housing to take away the heat generated in the housing.

According to one advantage of the present invention, the electric motor can be used in a high-temperature environment without being damaged. In a test, the electric motor was continuously operated in a closed space of 70 degrees C. for a long time without burning out.

Other objects, advantages, and novel features of the present invention will become more apparent from the following detailed description when taken in conjunction with the accompanying drawings.

### BRIEF DESCRIPTION OF THE DRAWINGS

FIG. 1 shows an exploded view of an electric motor according to one embodiment of the present invention.

FIG. 2 shows a 3-dimensional view of the electric motor.

FIG. 3 shows another 3-dimensional view of the electric motor, which is viewed from a different angle than FIG. 2.

FIG. 4 shows a 3-dimensional view of a cover used in the electric motor.

FIG. 5 shows another 3-dimensional view of the cover wherein an inner surface of the cover is shown.

FIG. 6 shows a side view of the electric motor.

FIG. 7 shows a sectional view of the electric motor, wherein some of the air current, which follows the airflow path (A) to enter the electric motor's housing for dissipating the heat generated in the electric motor, and some of the air current, which follows the airflow path (B) to cool down the electric motor's housing for dissipating the heat generated in the electric motor, are indicated.

FIG. 8 shows a front view of the electric motor, wherein some of the air current, which follows the airflow path (A) to enter the electric motor's housing for dissipating the heat generated in the electric motor, is indicated.

FIG. 9 shows a rear view of the electric motor, which demonstrates that the air current having entered the electric motor's housing may flow out of the housing via outlet holes to take away the heat generated in the housing.

### DETAILED DESCRIPTION OF THE PREFERRED EMBODIMENTS

Since the structure and operational principles of an electric motor have been known widely, a detailed description for the constituent parts thereof is not provided in the following paragraphs.

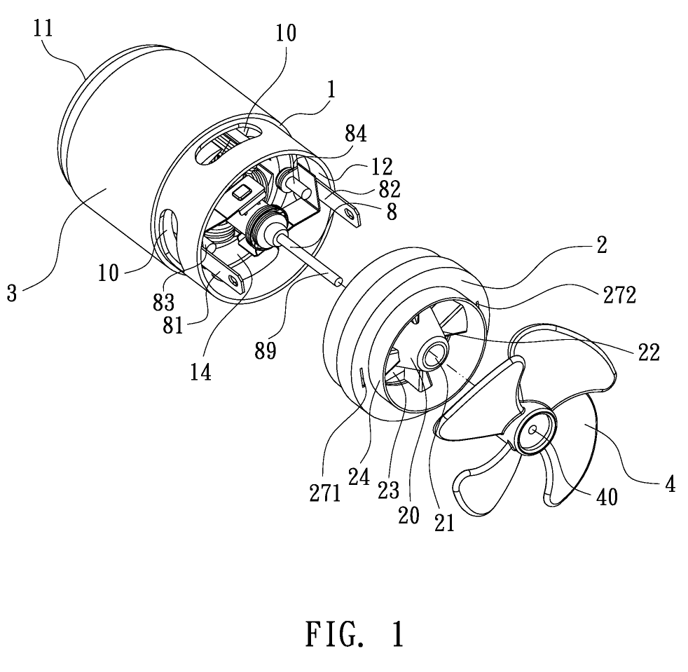

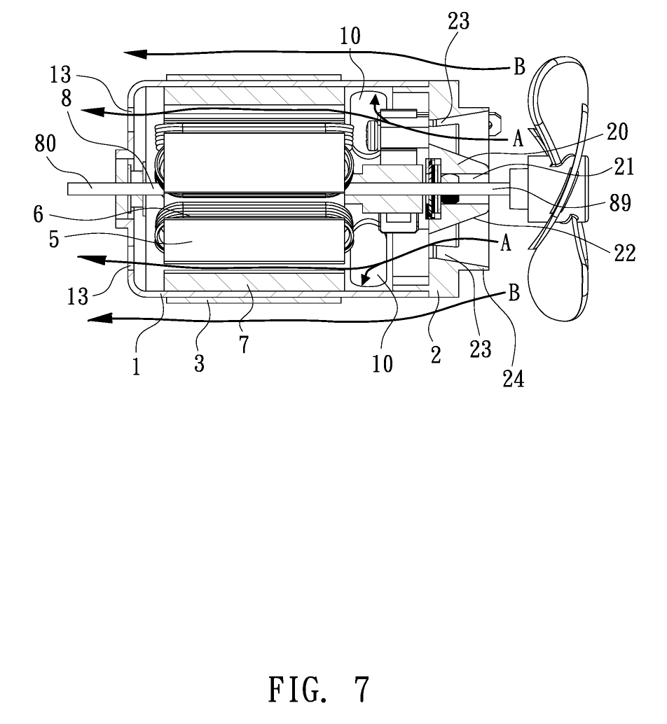

Referring first to FIGS. 1 through 3, an electric motor according to one embodiment of the present invention is shown, which generally includes a cylindrical housing 1, a cover 2, a rotating shaft 8, and a cooling fan 4. The housing 1 has a surrounding wall, which defines therein an inner space 14 with a front opening 12, and has a rear closure wall 11 opposite to the front opening 12. The rear closure wall 11 defines a central hole, in which a bearing may be mounted, and a plurality of outlet holes 13 around the central hole. The surrounding wall of the housing 1 defines a plurality of communication holes 10, through which the air within the housing 1 may flow into ambient environment. Furthermore, a rotor 5, coils 6 and magnets 7, which are necessary elements for an electric motor, are provided in the inner space 14 of the housing 1 (see FIG. 7). The rotating shaft 8 is mounted across the inner space 14 of the housing 1, wherein the rotating shaft 8 has a first end 80 which is inserted through the central hole of the rear closure wall 11 for connecting with a transmission mechanism (not shown) for providing necessary mechanical power. The rotating shaft 8 has a second end 89 which is inserted out of the front opening 12 of the housing 1 to be fitted with the cooling fan 4, as will be further illustrated below. A magnetically permeable sleeve 3, which can be made of metal, is closely fitted around the outer surface of the surrounding wall of the housing 1, to increase the performance of the electric motor.

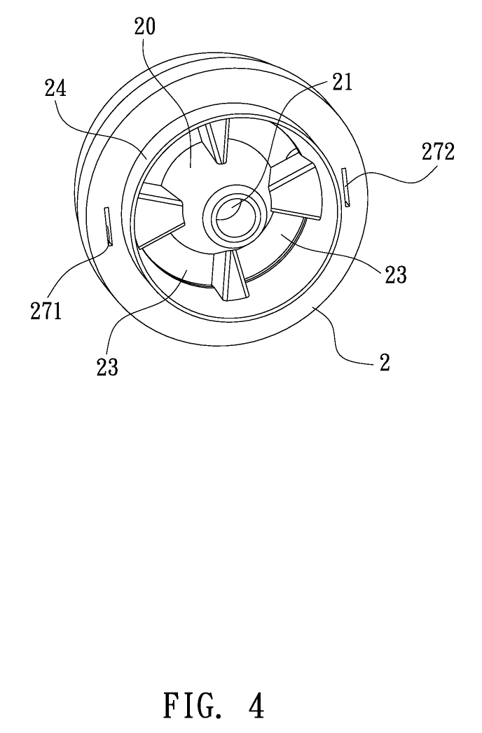

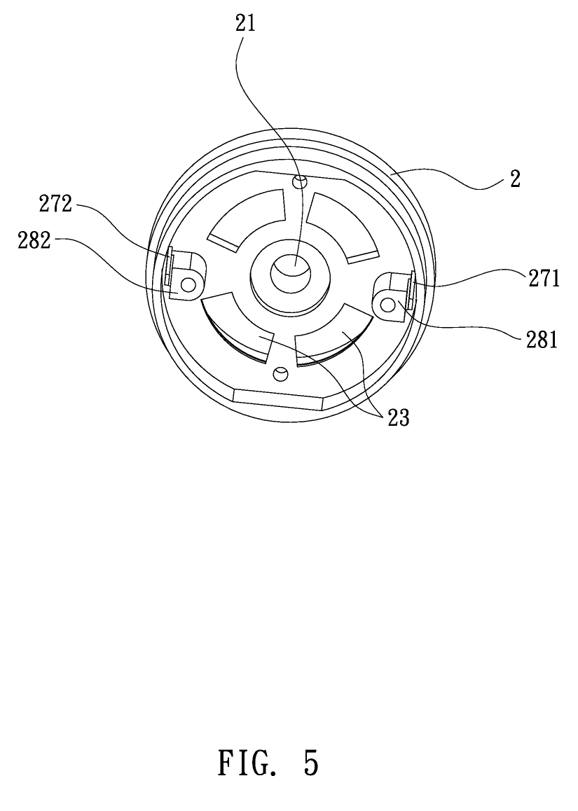

FIGS. 4 and 5 show the cover 2 used in the electric motor of the present invention, wherein the cover 2 has a central hub 20, which has a conical surface 22 and defines a central hole 21, and a peripheral portion integrally formed around the central hub 20. The central hub 20 tapers off from its round base which is formed integrally with the peripheral portion of the cover 2; namely, the diameter of a cross section of the central hub 20 is gradually reduced as compared to the round base of the central hub 20. The peripheral portion of the cover 2 is provided with an air collecting ring 24 around the central hub 20, and defines a plurality of inlet holes 23 between the air collecting ring 24 and the central hub 20. The air collecting ring 24 can be formed integrally with the peripheral portion of the cover 2. Furthermore, the cover 2 is provided with two mounting tubes 281, 282 at an inner surface of the peripheral portion thereof, and defines two through holes 271, 272 (see FIG. 5). When the cover 2 is installed to the housing 1, two electrical terminal blades 81, 82 provided in the housing 1 can be inserted through the two through holes 271, 272 of the cover 2, while two fixing dowel rods 83, 84 provided in the housing 1 can be inserted into the two mounting tubes 281, 282 of the cover 2, so that the cover 2 closes the front opening 12 of the housing 1, and electrical connection for the electrical motor is facilitated. While the cover 2 is being installed to the housing 1, the second end 89 of the rotating shaft 8 can be inserted through the central hole 21 of the central hub 20 of the cover 2, wherein a bearing (not shown) may be provided in the central hub 20 of the cover 2 and fitted with the second end 89 of the rotating shaft 8.

As shown in FIG. 1, the cooling fan 4 defines a central hole 40, into which the second end 89 of the rotating shaft 8 extending out of the central hole 21 of the cover 2 can be fitted, so that the cooling fan 4 is attached to and rotated together with the rotating shaft 8.

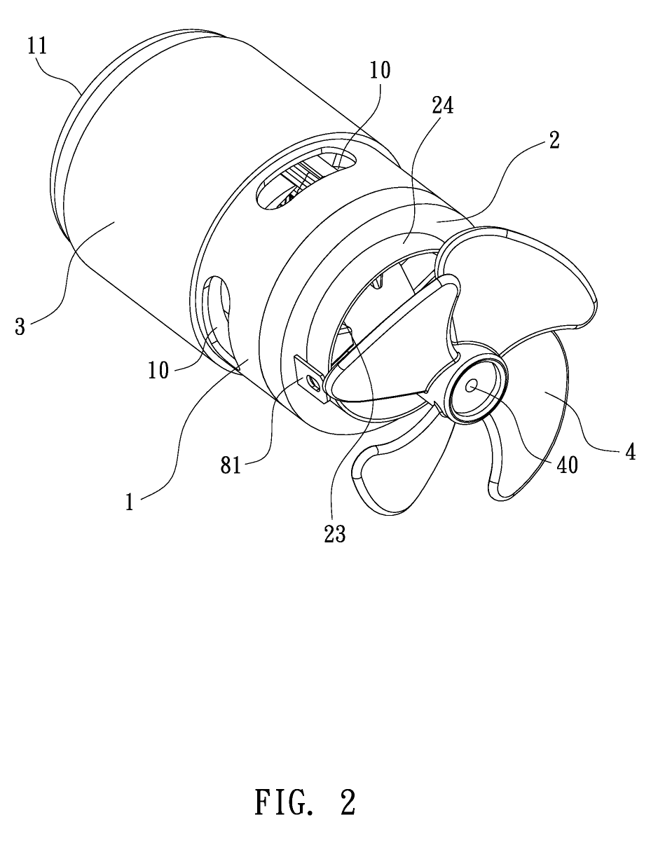

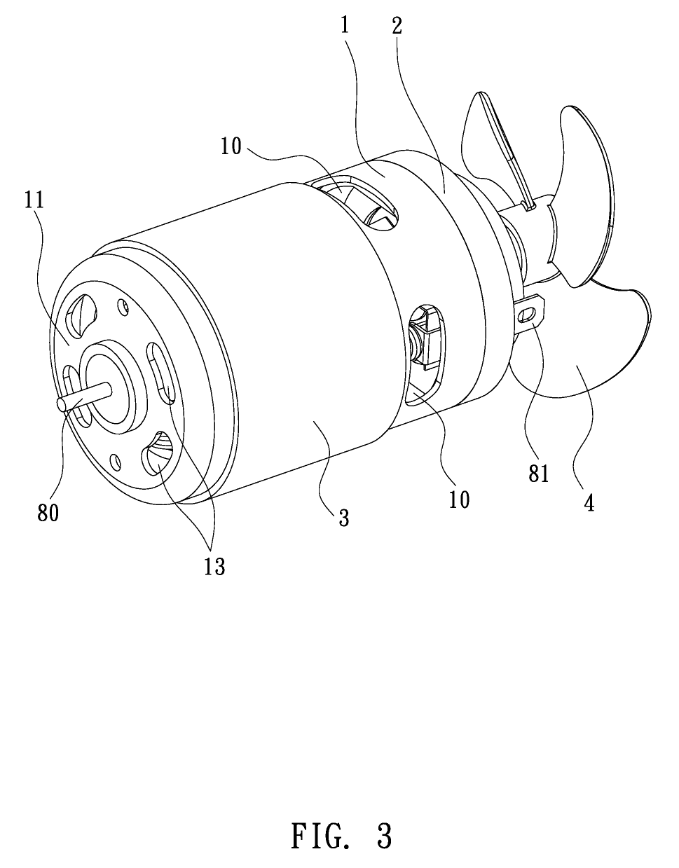

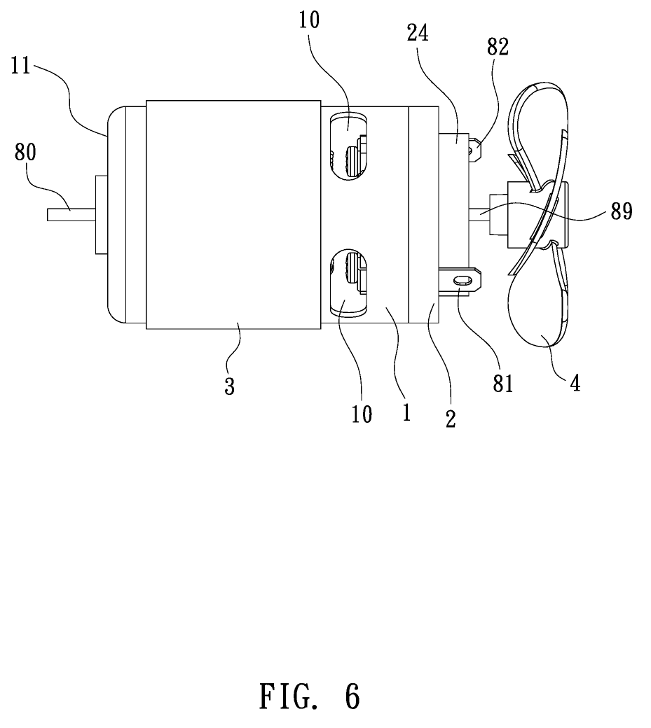

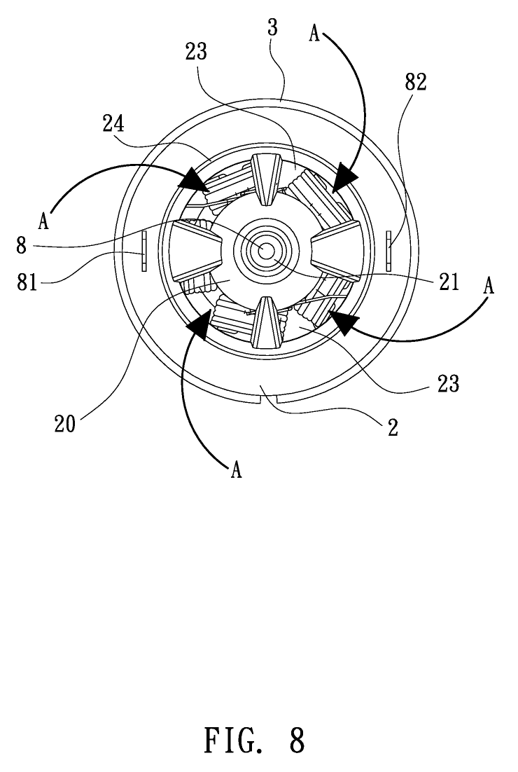

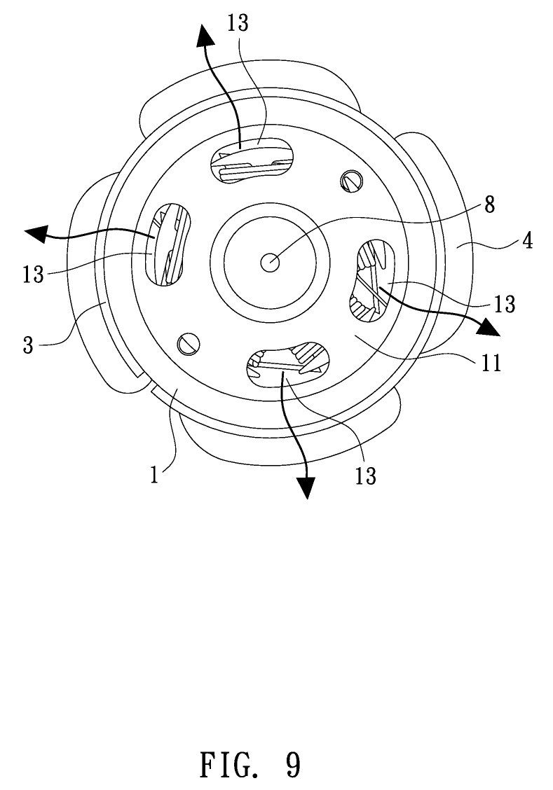

FIGS. 2 and 3 show an assembled electric motor, which are assembled from the housing 1, the cover 2, and the cooling fan 4. When the electric motor is started, the cooling fan 4 can be rotated together with the rotating shaft 8 to generate a whirling, ongoing air current towards the cover 2, so that the air at the right side of the cooling fan 4 can be forced to flow into the left side of the cooling fan 4 (see FIG. 6). In particular, the air current can enter the inner space 14 of the housing 1 easily, and the heat generated in the housing 1 can be dissipated effectively through multiple paths (see FIGS. 6 through 9). A central portion of the air current generated by the cooling fan 4 can be guided by the air collecting ring 24 of the cover 2 and the conical surface 22 of the central hub 20 to smoothly flow through the space between the air collecting ring 24 and the conical surface 22, and then to pass through the associated inlet holes 23 to enter the inner space 14 of the housing 1, as indicated by the airflow path (A) shown in FIGS. 7 and 8. In addition, an outer portion of the air current, which is outside the area of the air collecting ring 24 of the cover 2, may flow along the outer surface of the housing 1 or the sleeve 3 (see FIG. 7), so that the housing 1 can be effectively cooled down to facilitate dissipation of the heat generated in the housing 1. In this embodiment, the air current which has entered the inner space 14 of the housing 1 can flow out of the housing 1 via the outlet holes 13 and the communication holes 10 (see FIGS. 7 and 9), so that the heat generated in the housing 1 can be taken away with the leaving air current. The multiple airflow paths (A), (B) allow the heat generated in the housing 1 to dissipate more effectively, so that the electric motor can be prevented from burning out.

As a summary, the inlet holes 23 of the cover 2, with the assistance of the air collecting ring 24, allows the electric motor of the present invention to provide an airflow path (A) via which a central portion of the air current generated by the cooling fan 4 enters the inner space 14 of the housing 1 to dissipate the heat generated in the housing 1. In addition, the present invention provides another airflow path (B) via which an outer portion of the air current, which does not enter the inner space of the housing, flows along the outer surface of the housing 1 to lower the temperature of the housing 1 and thus to increase the capacity of dissipating the heat generated in the housing 1. Through multiple paths for heat dissipation, heat is not easy to accumulate in the housing 1 of the electric motor; therefore, maximum power output of the electric motor can be achieved, and thus the performance and service life of the electric motor can be increased. Even though the electric motor is operated in a high-temperature environment, it will not burn out. These features render the electric motor of the present invention useful and inventive.

Although the present invention has been described with a certain degree of particularity, it is understood that the present disclosure is made by way of example only and the combination and arrangement of parts may be resorted to without departing from the spirit and scope of the invention hereinafter claimed.

I claim:

1. In an electric motor including a housing, a cover, a rotating shaft, and a cooling fan, wherein the housing has a surrounding wall defining therein an inner space with a front opening and has a rear closure wall opposite to the front opening, the rear closure wall defining a central hole and a plurality of outlet holes; the cover, which closes the front opening of the housing, has a central hub defining a central hole and has a peripheral portion integrally formed around the central hub; the rotating shaft is mounted across the inner space of the housing, the rotating shaft having a first end which is inserted through the central hole of the rear closure wall and having a second end which is inserted through the central hole of the central hub of the cover; the cooling fan is fixed to the second end of the rotating shaft, so that the cooling fan is rotated together with the rotating shaft; wherein the improvement comprises:
the peripheral portion of the cover is formed integrally with an air collecting ring around the central hub and defines a plurality of inlet holes between the air collecting ring and the central hub, whereby a central portion of a whirling, ongoing air current generated by the cooling fan can flow through the space between the air collecting ring and the central hub of the cover and then flow through the inlet holes of the cover to enter the inner space of the housing and finally flow out of the housing via the outlet holes for dissipating the heat generated in the housing.

2. The electric motor of claim 1, wherein the central hub of the cover has a conical surface and tapers off from a round base thereof which is formed integrally with the peripheral portion of the cover.

3. The electric motor of claim 1, wherein the housing defines at least one communication hole at its surrounding wall, so that the air current having entered the inner space of the housing may flow out of the housing via the communication hole to take away the heat generated in the housing.

4. The electric motor of claim 1, wherein a sleeve made of a magnetically permeable metal is closely fitted around the surrounding wall of the housing to increase the performance of the electric motor.
